(19) United States
(12) Patent Application Publication
(10) Pub. No.: US 2014/0134422 A1
(43) Pub. Date: May 15, 2014

(54) IN-MOULD-FOAMING PROCESS USING A FOAMABLE MEDIUM WITH OUTER LAYERS, AND PLASTICS MOULDING OBTAINABLE THEREFROM

(71) Applicant: Cornelia Zimmermann, Seeheim-Jugenheim (DE)

(72) Inventors: Arnim Kraatz, Darmstadt (DE); Axel Zajonz, Bensheim (DE); Matthias Alexander Roth, Mobile, AL (US); Rainer Zimmermann, Seeheim-Jugenheim (DE)

(73) Assignee: Evonik Industries AG, Essen (DE)

(21) Appl. No.: 13/812,980

(22) PCT Filed: May 31, 2011
(86) PCT No.: PCT/EP2011/058869

§ 371 Date: Nov. 6, 2013

(30) Foreign Application Priority Data
Jul. 30, 2010 (DE) 10 2010 038 716.9

(51) Int. Cl. B29C 44/12

(52) U.S. Cl. CPC B29C 44/12
USPC 428/304.4; 264/46.4

(57) ABSTRACT

The use of a solid, foamable plastic, for example poly(meth)acrylimide (PMI), polyvinyl chloride (PVC), polyurethane (PU) or poly(meth)acrylate (PMMA), permits the production of a plastics foam composite moulding which is in essence homogeneous and which, in the course of the foaming process at about 200 degrees Celsius, forms a stable mechanical bond with an outer layer or a plurality of outer layers or with a plurality of identical or different outer layers.

### FIELD OF THE INVENTION

The invention relates to a single-stage foaming, laminating and moulding process for producing composite components, composed of a foam core made of a foamable medium, for example a foamable plastic and one or more outer layers made of plastics and/or composite materials and/or metals. The plastics foam composite mouldings have high mechanical strength and have lower mass than comparable metal components and therefore have excellent suitability as components in spacecraft, aircraft, watercraft and land vehicles and for other structural elements.

### PRIOR ART

Forming process for composite materials are known. By way of example, bladder moulding processes use a bladder made of, for example, silicone rubber in order to expand a parison made of a composite material, for example of glass-fibre-reinforced or carbon-fibre-reinforced plastic, in a mould, and to shape the parison to the mould and achieve thermal hardening of the same.

Bladder moulding process: in the bladder moulding process (used especially in the sports products industry, examples being bicycle frames, tennis racquets, etc.), outer layers made of fibre-reinforced plastics (FRP) are pressed and hardened at elevated internal pressure and elevated temperature by means of a silicone bladder. To this end, FRPs mostly having a thermoset matrix, these being known as prepregs, are inserted into a mould. In order to replicate the external shape of the mould, once the mould has been closed a silicone bladder is pressurized in the interior of the mould. The FRP is then hardened at a defined temperature. The mould is then opened, the component is demoulded and the silicone bladder is removed. In cases where, for reasons associated with the component, it is impossible to retrieve the bladder, “sacrificial cores” are used.

DE 198 45 269 (MBK) describes how a bladder surrounded by an air cushion is passed into a mould cavity of complicated shape and is then expanded, thus completely filling the mould cavity.

DE 10 2007 056 830 (Head) describes a bladder moulding process for producing tennis racquets made of composite materials.

The invention of DE 10 2007 051 517 (TU Dresden) relates to a hollow shaft or, respectively, hollow axis made of fibre composite material for interlocking with functional elements. The hollow shaft has at least two fibre layers in the jacket, different fibre orientations in the layers, and a profile with rounded edges. The functional elements have a profile contact area which corresponds to the profile of the shaft, and they have a functional area arrangement and a transition element located therebetween. The shaft according to the invention, and also the functional elements, have low weight.

DE 10 2004 015 072 (Röhm GmbH & Co. KG) describes a process for producing rods made of transparent plastics by extruding a plastics moulding composition, characterized in that an extruded plastics moulding composition is divided into two different strands and the plastics moulding composition 1 is used to extrude a plastics tube and, after entry into a vacuum-tank calibrator, after about 20 cm, the freshly extruded tube receives, in parallel, the previously isolated molten plastics moulding composition 2, and the new resultant plastics moulding is further processed as in conventional pipe extrusion.

DE 102 40 395 (Lisa Dräxlmaier GmbH) describes a transverse member which is intended for a motor vehicle and which hitherto has been produced from a steel tube by way of the internal high-pressure process; various means of receiving further parts can have been welded onto the transverse member. The transverse member according to the invention comprises a curved tube made of a fibre composite material or of metal-plastics-hybrid design, onto which the various means of accepting further parts have been injected.

DE 10 2009 002 232 (Volkswagen AG) describes a process and an apparatus for producing a camshaft, where the process is more flexible than the previous processes, for example internal high-pressure forming processes (IHU) or casting processes, and the products have lower weight. The camshaft is composed of fibre-reinforced plastic, and the production process is composed of the following steps:
the prefabricated load-introduction elements are arranged on the semifinished fibre product having a hollow structure,
an elastic hollow body is introduced into the semifinished fibre product and
the entire arrangement is placed in a temperature-controllable mould,
the load-introduction elements are positioned within the mould,
the elastic hollow body is filled, and the semifinished product is thus forced onto the shape of the mould and of the load-introduction elements,
a matrix material is inserted and thermally cured,
the shaft can be demoulded after curing.

DE 10 2007 026 553 (TU Dresden) describes a multicellular composite structure with an automobile-wheel profile for axes and shafts, for example for aircraft landing gear. The highly mechanical strength of the component is achieved via arrangement of the fibre layers at various angles.

DE 10 2005 020 274 (Denk Engineering GmbH) describes a process for producing a fibre-reinforced plastics moulding part by applying the fibre laminate to an extensible internal moulding part, introducing the fibre-laminate-covered internal moulding part into a negative mould and expanding the moulding part, where the internal moulding part expands and the fibre material is forced onto the inner wall of the component mould. Metal parts or previously hardened fibre-reinforced parts can be introduced into the component mould, and after the hardening of the fibre-reinforced material these have been bonded securely to the plastics moulding part and provide additional reinforcement thereof. The expansion of the core sheathing takes place via introduction of gas or of liquid, but can also take place via subatmospheric pressure.

DE 10 2005 020 907 A1 (TU Dresden) describes a hollow structure made of fibre-reinforced plastic with load-introduction elements which have been moulded onto the internal shape of the hollow structure. The hollow structure is composed of a textile semifinished product saturated with a reactive resin mixture. The reactive resin can be applied manually or by means of a known injection process, for example resin transfer moulding (RTM). A bladder is used to achieve precise shape replication.

The distinguishing features of “in-form moulding” using PU in essence:
In “normal” PU moulding foaming takes place into the component (the method being similar to that for construction foam).
PU is used to produce “sacrificial cores”, and these can then be covered by outer layers. The said process then comprises a plurality of steps.
In the case of PU, foaming takes place from the liquid phase.

In order to dissipate the energy of a motor-vehicle crash, crash elements are inserted within the structure of an automobile. These are generally produced by a forming process from metals, dissipating the energy by way of defined deformation (collapse) of the metallic structure when a load arises.

Individual specific applications (racing cars or sports cars produced in very small numbers) already use crash elements with a foam core and FRP outer layers. However, the production process differs fundamentally from the procedure according to the invention: fibres are applied in a second process step to a foam core placed in a mould, and a third process step is then used to consolidate these.

PU foams are used by way of example in vehicle body work to achieve a stiffening effect (including at locations subject to stress in a crash). These foams are injected directly into hollow metallic profiles, and expand during the introduction process (e.g. into the B-column of an automobile). The process here uses the possibility of in-situ foaming of the PU.

Object

Objects according to the invention are therefore:
Development of an in-situ foaming process,
development of a simple, single-stage process for producing three-dimensional components comprising foam (plastics foam composite mouldings),
development of a simple, single-stage process for producing three-dimensional components which comprise foam (plastics foam composite mouldings) and which have been sheathed by one and/or more outer layers, where the outer layers can have been bonded to one another,
production of lightweight-structure crash elements made of plastics foam composite mouldings,
production of mouldings and profile structures with foam core and an outer layer or a plurality of outer layers,
production of sheet-like plastics foam composite mouldings,
production of integral components with force-introducing structures (inserts) or bonding structures or stiffening structures,
in-situ production of foam foils,
sensors,
production of components with variable/adjustable density,
antenna (spacer),
production of elements for increasing pressure resistance and buckling resistance,
production of a very substantially homogeneous foam structure,
production of components with anisotropic mechanical properties,
stiffening of longitudinal and transverse members (e.g. A-, B- and C-columns in automobiles) via a plastics foam composite moulding.

Achievement of Object

The objects according to the invention are achieved as follows via a plastics foam composite moulding and via a process for producing the same:

Use of a solid, foamable plastic, such as poly(meth)acrylimide (PMI), polyvinyl chloride (PVC), polyurethane (PU), or poly(meth)acrylate, (PMMA) permits production of a plastics foam composite moulding which is in essence homogeneous and which, in the course of the foaming process, forms a stable mechanical bond with an outer layer or with a plurality of identical or different outer layers.

“Stable mechanical” hereinafter means that the force required to release the outer layer (test method: drum peel test according to DIN 53295) is greater than the peel forces typical of the material. For ROHACELL®, these are in the range from 10 to 80 Nmm/mm.

The Outer Layers

The outer layers of the plastics foam composite moulding can by way of example be composed of:
thermoplastic materials with or without reinforcement materials, examples being various types of polyamide (PA, PA 66, PA 12), polypropylene (PP), polybutylene terephthalate (PBT), polyether ether ketone (PEEK) with optional reinforcement by, for example, glass fibres, aramid fibres, polymer fibres, natural fibres or carbon fibres, an example being PA 6 GF
thermoplastic fibre composite materials or organopanels, for example continuous-fibre-reinforced PA 6
thermoset materials with or without reinforcement materials, examples being prepregs
only reinforcement materials, examples being fibres made of glass, carbon, aramid, polymer, for example basalt fibres, boron fibres, ceramic fibres, metal fibres, polyester fibres, nylon fibres, polyethylene fibres, Plexiglas fibres, natural fibres, such as wood fibres, flex fibres, hemp fibres, sisal fibres
metals, examples being aluminium, high-strength steel or other steel
elastomers, such as rubber, PU, fibre-reinforced rubber or fibre-reinforced PU
gel coats
and combinations made of one or more of the abovementioned materials, examples being multilayer structures (laminates) made of combinations of laid glass-fibre scrim and laid carbon-fibre scrim.

Reinforcement materials that can be used for the outer layers of the plastics foam composite moulding are the fibre materials conventional in plastics technology, examples being:
glass fibres, for example in the form of short glass fibres, long glass fibres, continuous-filament fibres, laid fibre scrims, woven fibres, knits, non-wovens or mats
carbon fibres, for example in the form of short glass fibres, long glass fibres, continuous-filament fibres, laid fibre scrims, woven fibres, knits, non-wovens or mats
aramid fibres, for example in the form of short glass fibres, long glass fibres, continuous-filament fibres, laid fibre scrims, woven fibres, knits, non-wovens or mats
natural fibres, examples being wood fibres, flex fibres, hemp fibre, sisal fibres
synthetic fibres, examples being polyester fibres, nylon fibres, polyethylene fibres, Plexiglas fibres
glass beads, an example being glass-bead-reinforced polyamide (e.g. PA 6 GR30)

The outer layers can also have been adhesive-bonded to one another.

### The poly(meth)acrylimide and the poly(meth)acrylimide foam

The core layers that are particularly relevant for the process of the invention comprise a poly(meth)acrylimide foam.

The bracketed expressions are intended to characterize an optional feature. By way of example, therefore, (meth)acrylic means not only acrylic compounds but also methacrylic compounds and mixtures of the two.

The poly(meth)acrylimide foams obtainable from the compositions according to the invention have repeat units that can be represented via formula (I),

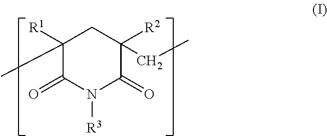

in which
R¹ and R², identical or different, are hydrogen or a methyl group and R³ is hydrogen or an alkyl or aryl moiety having up to 20 carbon atoms.

It is preferable that units of the structure (I) form more than 30% by weight of the poly(meth)acrylimide foam, particularly more than 50% by weight and very particularly more than 80% by weight.

The production of rigid poly(meth)acrylimide foams is known per se and is described by way of example in GB Patent 1 078 425, GB Patent 1 045 229, DE Patent 1 817 156 (=U.S. Pat. No. 3,627,711) or DE Patent 27 26 259 (=U.S. Pat. No. 4,139,685) or DE 199 17 987.

By way of example, the units of the structural formula (I) can inter alia form from adjacent units of (meth)acrylic acid and of (meth)acrylonitrile via a cyclizing isomerization reaction on heating to from 150° C. to 250° C. (cf. DE-C 18 17 156, DE-C 27 26 259, EP-B 146 892). In the usual method, a precursor is first produced via polymerization of the monomers in the presence of a free-radical initiator at low temperatures (e.g. from 30° C. to 60° C.) with subsequent heating to from 60° C. to 120° C., and this is then foamed by a blowing agent that is present, via heating to about 180° C. to 250° C. (see EP-B 356 714).

To this end, by way of example, a copolymer can first be formed, comprising (meth)acrylic acid and (meth)acrylonitrile in a molar ratio which is preferably from 1:3 to 3:1.

The said copolymers can moreover comprise further monomer units which derive by way of example from esters of acrylic or methacrylic acid, in particular with lower alcohols having from 1 to 4 carbon atoms, or from styrene, from maleic acid or its anhydride, from itaconic acid or its anhydride, from vinylpyrrolidone, from vinyl chloride or from vinylidene chloride. The proportion of the comonomers which cannot be cyclized or can be cyclized only with great difficulty is not to exceed the following values, based on the weight of the monomers: 30% by weight, preferably 20% by weight and particularly preferably 10% by weight.

Other monomers that can be used with advantage in a likewise known manner are small amounts of crosslinking agents, e.g. allyl acrylate, allyl methacrylate, ethylene glycol diacrylate or ethylene glycol dimethacrylate, or polyvalent metal salts of acrylic or methacrylic acid, e.g. magnesium methacrylate. The quantitative proportions of the said crosslinking agents are frequently within the range from 0.005% by weight to 5% by weight, based on the total amount of polymerizable monomers.

It is moreover possible to use metal salt additions, where these often act to reduce the amount of smoke. Among these are inter alia the acrylates or methacrylates of the alkali metals or of the alkaline earth metals or of zinc, of zirconium or of lead. Preference is given to the (meth)acrylate of Na—, of K, of Zn, and of Ca. Amounts of from 2 to 5 parts by weight of the monomers markedly reduce smoke density in the fire test according to FAR 25.853a.

The Polymerization Initiators

Polymerization initiators used comprise those which are per se conventional for the polymerization of (meth)acrylates, examples being azo compounds, such as azodiisobutyronitrile, and also peroxides, such as dibenzoyl peroxide or dilauroyl peroxide, and also other peroxide compounds, such as tert-butyl peroctanoate, or perketals, and also optionally redox initiators (in which connection cf. by way of example H. Rauch-Puntigam, Th. Völker, Acryl-und Methacrylverbindungen [Acrylic and methacrylic compounds], Springer, Heidelberg, 1967, or Kirk-Othmer, Encyclopedia of Chemical Technology, Vol. 1, Pages 286 ff, John Wiley & Sons, New York, 1978). The amounts preferably used in the polymerization initiators are from 0.01 to 0.3% by weight, based on the starting materials.

It can also be advantageous to combine polymerization initiators with different decomposition properties in relation to time and temperature. An example of a very suitable method is simultaneous use of tert-butyl perpivalate, tert-butyl perbenzoate and tert-butyl 2-ethylperhexanoate, or of tert-butyl perbenzoate, 2,2-azobisiso-2,4-dimethylvaleronitrile, 2,2-azobisisobutyronitrile and di-tert-butyl peroxide.

The Regulators

The molecular weights of the copolymers are adjusted via polymerization of the monomer mixture in the presence of molecular-weight regulators, particular examples being the mercaptans known for this process, for example n-butyl mercaptan, n-dodecyl mercaptan, 2-mercaptoethanol or 2-ethylhexyl thioglycolate, or else quinones or terpenes, where the amounts generally used of the molecular-weight regulators are from 0.01% by weight to 5% by weight, based on the monomer mixture, preferably from 0.1% by weight to 2% by weight and particularly preferably from 0.2% by weight to 1% by weight based on the monomer mixture (cf. by way of example H. Rauch-Puntigam, Th. Völker, “Acryl- and Methacrylverbindungen” [Acrylic and methacrylic compounds], Springer, Heidelberg, 1967; Houben-Weyl, Methoden der organischen Chemie [Methods of organic chemistry], Vol. XIV/1, Page 66, Georg Thieme, Heidelberg, 1961 or Kirk-Othmer, Encyclopedia of Chemical Technology, Vol. 1, Page 296ff, J. Wiley, New York, 1978).

The polymerization process preferably uses variants of the bulk polymerization process, for example what is known as the cell process, without restriction thereto.

The weight-average molar mass M̅_{w} of the polymers is preferably greater than 10⁶ g/mol, in particular greater than 3×10⁶ g/mol, with no intended resultant restriction.

The foaming of the copolymer during conversion to a polymer containing imide groups is achieved in a known manner by using blowing agents, where these form a gas phase at from 150° C. to 250° C. via decomposition or vaporization. Blowing agents having amide structure, e.g. urea, monomethyl- or N,N′-dimethyl urea, formamide or monomethylformamide, decompose with liberation of ammonia or amines, which can contribute to additional formation of imide groups. However, it is also possible to use nitrogen-free blowing agents, such as formic acid, water or monohydric aliphatic alcohols having from 3 to 8 carbon atoms, such as 1-propanol, 2-propanol, n-butan-1-ol, n-butan-2-ol, isobutan-1-ol, isobutan-2-ol, pentanols and/or hexanols.

The amount used of blowing agent depends on the desired foam density, but the usual amounts of the blowing agents in the reaction mixture here are about 0.5% by weight to 15% by weight, based on the monomers used.

The precursors can moreover comprise conventional additives. Among these are inter alia antistatic agents, antioxidants, mould-release agents, lubricants, dyes, flame retardants, flow improvers, fillers, light stabilizers and organophosphorus compounds, such as phosphites or phosphonates, pigments, weathering stabilizers and plasticizers.

Another class of preferred additives is provided by conductive particles, where these inhibit electrostatic charging of the foams. Among these are inter alia metal particles and carbon black particles, which respectively can also be present in the form of fibres, with size in the range from 10 nm to 10 mm, as described in EP 0 356 714 A1.

One particularly preferred poly(meth)acrylimide foam that can be used can be obtained by way of example via the following steps:
1. Production of copolymer sheet via free-radical copolymerization of a composition composed of
   (a) a monomer mixture made of from 20% by weight to 60% by weight of methacrylonitrile, from 80% by weight to 40% by weight of methacrylic acid and optionally up to 20% by weight, based on the entirety of methacrylic acid and methacrylonitrile, of further monofunctional, vinylically unsaturated monomers
   (b) from 0.5% by weight to 15% by weight of a blowing agent mixture made of formamide or monomethylformamide and of a monohydric aliphatic alcohol having from 3 to 8 carbon atoms in the molecule
   (c) a crosslinking agent system which is composed of
      (c.1) from 0.005% by weight to 5% by weight of a vinylically unsaturated compound which can be subjected to free-radical polymerization and which has at least two double bonds in the molecule and
      (c.2) from 1% by weight to 5% by weight of magnesium oxide or zinc oxide, dissolved in the monomer mixture
   (d) an initiator system
   (e) conventional additives
   (f) a regulator or regulator mixture
2. This mixture is polymerized for a number of days at from 30° C. to 45° C. in a cell formed from two glass sheets of size 50*50 cm and from an edge seal of thickness 2.2 cm. The copolymer is then subjected to a heat-conditioning program extending from 40° C. to 130° C. for about 20 h or final poly(meth)acrylimide copolymerization.
The subsequent foaming takes place during a period of some hours at from 170° C. to 250° C., preferably at from 200° C. to 250° C. and very particularly preferably at from 220° C. to 250° C.

Poly(meth)acrylimides with high heat resistance can moreover be obtained via reaction of polymethyl(meth)acrylate or its copolymers with primary amines, where these can likewise be used according to the invention. The following may be mentioned as representative of the large number of examples of the said polymer-analogous imidation process: U.S. Pat. No. 4,246,374, EP 216 505 A2, EP 860 821. High heat resistance can be achieved here either via use of arylamines (JP 05222119 A2) or via the use of specific comonomers (EP 561 230 A2, EP 577 002 A1). However, all of the said reactions give solid polymers rather than foams, and to obtain a foam these have to be foamed in a separate second step. Again, there are techniques known to a person skilled in the art for this purpose.

Rigid copoly(meth)acrylimide foams can also be obtained commercially, an example being Rohacell® from Evonik Röhm GmbH, which can be supplied in various densities and sizes.

The density of the copoly(meth)acrylimide foam is preferably in the range from 20 kg/m³ to 320 kg/m³, particularly preferably in the range from 50 kg/m³ to 110 kg/m³.

Without any intended resultant restriction, the thickness of the core layer is in the range from 1 mm to 1 000 mm, in particular in the range from 5 mm to 500 mm, and very particularly preferably in the range from 10 mm to 200 mm.

The core layer can also have further layers in the interior. However, the materials bonded by the process of the present invention are a copoly(meth)acrylimide foam specifically and/or outer layers (see above). However, particular embodiments of the process according to the invention use a core layer which is composed of copoly(meth)acrylimide foam.

It is also possible that poly(meth)acrylates are used as plastics to be foamed.

The Production Process

The production process for the plastics foam composite product is composed of the following steps:
1. Production of the plastics moulding. The plastics moulding is an unfoamed moulding and is converted by mechanical methods to the dimensions required. The dimensions depend on the foam density to be set in the finished plastics foam composite product. Given the known density of the copolymer, a constant foaming factor arises, based on the target density, because of the isotropic foaming behaviour. This factor can be used to calculate the dimensions of the required copolymer.
2. The outer layer is placed in the mould, and a release means can optionally be applied between mould and outer layer, in order to facilitate demoulding of the plastics foam composite product.
3. The foaming and bonding of the resultant foam to the outer layer(s) are carried out in a step at temperatures of from 170 degrees Celsius to 250 degrees Celsius, preferably from 200° C. to 250° C. and very particularly preferably from 220° C. to 250° C.
   The foaming time is from half an hour to five hours, preferably from one and a half hours to four hours and very particularly preferably from two hours to three hours.
4. After cooling, the plastics foam composite product can be removed from the mould.

There is a restriction placed upon the material from which the mould is produced, insofar as it must be capable of withstanding the temperatures of the foaming process. It is moreover advantageous if the internal side of the mould is smooth, in order to facilitate the demoulding of the plastics foam composite moulding and to achieve a smooth surface of the plastics foam composite moulding.

The plastics foam composite mouldings obtainable according to the process according to the invention are suitable, on the basis of their low weight and of their excellent mechanical properties, as a component in spacecraft, aircraft, watercraft and land vehicles, and in particular as components which deform in a manner that absorbs energy in the event of an accident (crash elements).

### EXAMPLES

### Example 1

The plastics moulding is produced in accordance with the specification according to example 1 of DE 199 17 987 A 1.

A mixture made of about 61 parts of methacrylic acid, about 39 parts of methacrylonitrile, about 4.7 parts of formamide and 4.2 parts of propan-2-ol (isopropanol) and of an initiator mixture made of 0.3 part of tert-butyl pivalate, of 0.04 part of tert-butyl 2-ethylhexanoate, of 0.07 part of tert-butyl perbenzoate and of 0.077 part of cumyl perneodecanoate is polymerized with 0.001 part of chain-transfer agent between two glass sheets separated by 23 mm and sealed by a peripheral sealing bead, for about 66 hours at a water-bath temperature of 38 degrees Celsius, with subsequent post-polymerization for 24 hours in an oven at a temperature of 115 degrees Celsius. This gives a uniform plastics moulding. (“Parts” in the above example always mean parts by weight.)

### Example 2

A polyamide foil (organopanel: produced by Bond Laminates GmbH, Briton, TEPEX® dynalite 102-RG600(1)/47%, 0.50 mm black (PA6+GF)) is placed on the internal side of a cylindrical mould of diameter 53.5 mm and length 265 mm in such a way that it is in contact with the internal edge of the mould. A poly(meth)acrylimide polymer constituted according to example 1 and measuring 98×17.5×17.5 mm is placed in the mould, and the mould is heated to 220 degrees Celsius for a period of about 2 hours.

Cooling gives a plastics foam composite moulding with the following mechanical properties:
The density of the component can be adjusted in the range from 10 kg/m³to 300 kg/m³, but preferably in the range from 50 kg/m³to 200 kg/m³.
Throughout the entire core of the component, a relatively (a term which requires more explanation) homogeneous, i.e. closed-cell foam structure with no significant preferential direction is present.
The core of the component features uniform cell size distribution (the cell sizes being in the range from 0.05 to 0.8 mm, preferably in the range from 0.2 to 0.6 mm, varying with the target density required).
The structure of the foam core is almost 100% closed-cell.
There is very good coupling/adhesion to the outer layers. “Very good coupling/adhesion” hereinafter means that the force required to release the outer layer (test method and Standard: drum peel test according to DIN 53295) is greater than the peel forces typical of the material. For ROHACELL, these are in the range from 10 to 80 Nmm/mm.
The process achieves very good shaping. Three-dimensional geometries with very small radii can be replicated.
Replication of three-dimensional geometry is very good. This means that the process achieves high degrees of forming of the foam core and of the outer layers.
The composite moulding has a smooth external skin.
The plastics composite moulding has very good fibre consolidation. High temperatures (range see above) are introduced into the component in order to initiate the foaming process. This leads to melting of the materials by way of example in the case of thermoplastic matrix systems of the outer layers (an example being organopanel). The foaming process moreover applies high pressures to the outer layers. This leads to good consolidation of the fibres present.
The composite permits absorption of large amounts of energy. The large amounts of energy absorbed are the result not only of the fibre-reinforced outer layers but also of the foam core: in the event of exposure to large amounts of energy (for example a crash) cracks will form in the outer layer once the strength value has been exceeded. These “migrate” from fibre to fibre and thus “consume” energy. The situation with the foam is as follows: when the strength value is exceeded the process known as collapse occurs to the first cells. A complete plane of cells then collapses, then the next, then the next, etc. Energy is thus dissipated by virtue of the repeated “encounter with an obstacle (intact plane of cells)”.
The plastics composite moulding has high flexural and torsional stiffness values, high buckling stress, and very good buckling performance. The good mechanical properties derive in essence from the sandwich-construction principle. Sandwich construction is a type of construction for semifinished products where a plurality of layers of various properties are embedded within a material. It is very frequently used in combination with fibre composite materials, such as fibre-plastics composites. Sandwich construction is a type of structure in which the components are composed of force-absorbing outer plies which are separated by a relatively lightweight core material. The said parts are very resistant to bending and buckling, with low weight. Linear sandwich theory is used for the relevant calculations. The core material can be composed of paper honeycombs, of foams (rigid foam) or of balsa wood. Since by way of example when a “bending” load arises it is especially the exterior plies that absorb the tensile and compressive forces, the core sheet used can be composed of lower-weight material, being responsible merely for transmitting the shear forces.

### Example 3

A polyamide foil (organopanel: Bond Laminates TEPEX® dynalite 102-RG600(1)/47%, 0.50 mm black (PA6+GF)) is placed on the internal side of a cylindrical mould of diameter 53.5 mm and length 265 mm in such a way that it is in contact with the internal edge of the mould. A poly(meth)acrylimide polymer constituted according to example 1 is placed in the mould. A steel bar with dimensions 12×12 mm (square) and length 245 mm is also placed in the mould in such a way that the polyamide foil does not sheath the steel bar, and the mould is heated to about 220 degrees Celsius for about 2 hours.

After cooling, a plastics foam composite moulding is obtained with a groove measuring 12×12 mm depth, with the following mechanical properties:
The density of the component can be adjusted in the range from 10 kg/m³ to 300 kg/m³, but preferably in the range from 50 kg/m³to 200 kg/m³.
Throughout the entire core of the component, a relatively homogeneous, i.e. closed-cell foam structure with no significant preferential direction is present.
The core of the component features uniform cell size distribution (the cell sizes being in the range from 0.05 to 0.8 mm, preferably in the range from 0.2 to 0.6 mm, varying with the target density required).
The structure of the foam core is almost 100% closed-cell.
There is very good coupling/adhesion to the outer layers. “Very good coupling/adhesion” hereinafter means that the force required to release the outer layer (test method and Standard: drum peel test according to DIN 53295) is greater than the peel forces typical of the material. For ROHACELL, these are in the range from 10 to 80 Nmm/mm.
The process achieves very good shaping. Three-dimensional geometries with very small radii can be replicated. The shape of the steel bar is well replicated.
Replication of three-dimensional geometry is very good. This means that the process achieves high degrees of forming of the foam core and of the outer layers.
The composite moulding has a smooth external skin.
The plastics composite moulding has very good fibre consolidation. High temperatures (range see above) are introduced into the component in order to initiate the foaming process. This leads to melting of the materials by way of example in the case of thermoplastic matrix systems of the outer layers (an example being organopanel). The foaming process moreover applies high pressures to the outer layers. This leads to good consolidation of the fibres present.
The composite permits absorption of large amounts of energy. The large amounts of energy absorbed are the result not only of the fibre-reinforced outer layers but also of the foam core: in the event of exposure to large amounts of energy (for example a crash) cracks will form in the outer layer once the strength value has been exceeded. These “migrate” from fibre to fibre and thus “consume” energy. The situation with the foam is as follows: when the strength value is exceeded the process known as collapse occurs to the first cells. A complete plane of cells then collapses, then the next, then the next, etc. Energy is thus dissipated by virtue of the repeated “encounter with an obstacle (intact plane of cells)”.
The plastics composite moulding has high flexural and torsional stiffness values, high buckling stress, and very good buckling performance. The good mechanical properties derive in essence from the sandwich-construction principle. Sandwich construction is a type of construction for semifinished products where a plurality of layers of various properties are embedded within a material. It is very frequently used in combination with fibre composite materials, such as fibre-plastics composites. Sandwich construction is a type of structure in which the components are composed of force-absorbing outer plies which are separated by a relatively lightweight core material. The said parts are very resistant to bending and buckling, with low weight. Linear sandwich theory is used for the relevant calculations. The core material can be composed of paper honeycombs, of foams (rigid foam) or of balsa wood. Since by way of example when a “bending” load arises it is especially the exterior plies that absorb the tensile and compressive forces, the core sheet used can be composed of lower-weight material, being responsible merely for transmitting the shear forces.

1. A process for producing a plastic foam composite molding,
the process comprising:
introducing an outer layer and a solid poly(meth)acrylimide copolymer into a mold and, then foaming the poly(meth)acrylimide copolymer and bonding the poly(meth)acrylimide copolymer to the outer layer.

2. The process of claim 1,
wherein
the foaming is at from 170 degrees Celsius to 250 degrees Celsius.

3. The process of claim 1, comprising:
producing a plastic foam composite molding in a single process.

4. A plastic foam composite molding obtained by a process comprising the process of claim 1.

5. The plastic foam composite molding of claim 4, wherein the plastic foam composite molding is suitable for a component in spacecraft, aircraft, watercraft, a land vehicle, or any combination thereof.

6. The plastic foam composite molding of claim 4, wherein the plastic foam composite molding is suitable for an energy-absorbing component in spacecraft, aircraft, watercraft, a land vehicle, or any combination thereof.

7. The plastic foam composite moulding molding of claim 4, wherein the plastic foam composite molding is suitable for a stabilizing component in spacecraft, aircraft, a land vehicle, or any combination thereof.

8. The process of claim 1, wherein
the foaming is at from 200 degrees Celsius to 250 degrees Celsius.

9. The process of claim 1, wherein
the foaming is at from 220 degrees Celsius to 250 degrees Celsius.

10. A method of manufacturing a component in spacecraft, aircraft, watercraft, a land vehicle, or any combination thereof, comprising the plastic foam composite molding of claim 4.

11. A method of manufacturing an energy-absorbing component in spacecraft, aircraft, watercraft, a land vehicle, or any combination thereof, comprising the plastic foam composite molding of claim 4.

12. A method of manufacturing as a stabilizing component in spacecraft, aircraft, watercraft, a land vehicle, or any combination thereof, comprising the plastic foam composite molding of claim 4.
